(19) United States
(12) Patent Application Publication
(10) Pub. No.: US 2023/0222272 A1
(43) Pub. Date: Jul. 13, 2023

(54) A METHOD FOR MATRIX-ACID STIMULATION DESIGN IN LIMITED ENTRY LINERS

(71) Applicant: Abu Dhabi National Oil Company, Abu Dhabi (AE)

(72) Inventor: Kristian MOGENSEN, Abu Dhabi (AE)

(21) Appl. No.: 18/001,405

(22) PCT Filed: Jun. 11, 2021
(86) PCT No.: PCT/IB2021/055165

§ 371 Date: Dec. 9, 2022

(30) Foreign Application Priority Data
Jun. 12, 2020 (EP) 20179814.7

(51) Int. Cl. G06F 30/28

(52) U.S. Cl. CPC G06F 30/28; E21B 17/00

(57) ABSTRACT

A method for stimulation of a well in a material formation which includes a workflow for the design of hole-size distribution in the liner of a LEL liner system is modelled, wherein a solution strategy for providing an initial estimate of the number of holes per segment honours the acid coverage per segment and the drop in pressure (dp) across the last one of the holes, where the initial estimate can be found from the relationship between interstitial velocity, pump rate, and total cross-sectional hole area for a particular discharge coefficient and liner configuration.

### FIELD OF THE INVENTION

The invention relates to fluid transport in a system for stimulating an oil or gas well in a carbonate petrochemical reservoir.

### BACKGROUND OF THE INVENTION

The purpose of stimulation is to the enhance productivity of an oil or gas well while minimizing the amount of stimulation fluid introduced into the oil or gas well. A common stimulation method for oil or gas wells in carbonate reservoirs is acid stimulation whereby the selected acid is allowed to chemically react with the reservoir rock (a carbonate), which leads to dissolution of the reservoir rock and enhanced productivity for the oil or gas well.

For those oil or gas wells which are completed “open-hole”, a complicating factor is acid placement of the acid in the well, i.e. the ability to distribute the acid across the entire section of the reservoir. “Bull-heading” the acid from the surface typically results in a mediocre stimulation treatment of the well because the majority of the acid is spent reacting at the heel of the well.

In order to ensure correct acid placement and efficient use of the acid, the so-called “limited entry liner (LEL)” technique has been introduced. The LEL is a liner with a plurality of holes distributed along its length for diversion of the acid into the reservoir rock. The LEL technique was developed for the acid distribution and acid stimulation of long horizontal wells and is also termed as “controlled-acid jetting (CAJ)”. An acidization process of the reservoir rock using the LEL can be represented in several different mathematical ways. A first mathematical way is a fully transient approach in the movement of an acid front is tracked against time. This fully transient approach is also termed a “transient simulator” and is useful for matching (and/or reproducing) historical pressure data and flow rate data from an existing acid stimulation process. The first mathematical way assumes that hole size distribution of hole sizes of the plurality of holes has been optimized and uses this hole size distribution as an input in the calculation. The transient simulator attempts to capture the physics of a chemical reaction between the acid and the rock that is required for an increase in productivity of the oil or gas well. The transient simulation takes into account the dissolution patterns of the acid in the rock. These dissolution patterns are called “wormholes”. These dissolution patterns depend on, for example, an injection velocity of the acid, a rock type of the rock, a permeability, or an injection temperature of the acid. The transient simulators require significant calculation power, and the transient simulation is therefore time consuming.

A second mathematical way for the modelling of the acidization process using the LEL is a steady-state approach. Variations in pump rate of the acid in the LEL are ignored in this steady state approach and only the final acid distribution of the acid is evaluated in the steady state simulation. This steady-state approach is fast and makes it possible to change the distribution of the hole size using computer software to match a desired acid coverage of the acid in each segment of the LEL along the well.

The concept for the acidization process is the distribution of the plurality of holes in the LEL. These holes can be of varying sizes and/or can be spaced at intervals along the LEL and act as flow restrictions. This dimensioning and positioning of the holes leads to mechanical changes in flow of the acid along the LEL. An appropriate design of the hole size distribution is capable of ensuring that the reservoir section is treated with the acid and that the acid is efficiently used in the acidization process. Aspects in the calculation of the hole size distribution has been addressed in a number of references listed below.

A further complicating factor is to ensure maximum acid penetration of the acid into the reservoir rock. The acid is an expensive commodity and should not be spent on dissolving all of the rock in the near-wellbore area, i.e. in the near proximity of the LEL. Rather, the stimulation programme should be designed in such a way that the acid penetrates as far as possible into the rock formation because this situation leads to the highest negative skin and hence the highest productivity index.

Lab experiments by a number of authors clearly show that, for any given rock formation, the acid penetration depends on the interstitial velocity of the acid. There exists an optimum velocity, which minimizes the amount of the acid needed to generate deep dissolution patterns (i.e. the wormholes). This optimum velocity depends on the rock, and the acid system (type, concentration, temperature). In addition to ensuring uniform acid coverage, the hole-size distribution must also be designed in such a way that it maximizes the propagation of wormholes through the rock formation.

A further problem pertains to acid stimulation of both vertical and horizontal wells. The challenge is to achieve uniform stimulation throughout the completed well trajectory of the well. Some operators choose not to stimulate the wells, other operators bullhead from the wellhead, other operators stimulate through a coiled tubing. Segmented completions which allow the acidization in stages and use of diverters is employed. A few operators make use of the Limited Entry Liner (LEL) concept, but do not describe a comprehensive workflow for the hole size design. The design of LEL in terms of varying hole sizes and frequency remain a subject matter of challenge because of multiplicity of considerations.

In EP 1 184 537B1, the authors describe the LEL concept (called controlled acid jet) for matrix-acid stimulation and develop a steady-state model using polynomial approximation with orthogonal collocation. However, their model assumes a constant friction factor and does not describe a workflow for design of the optimum hole size distribution. Their model does not estimate the maximum design rate, does not take into account the experimental wormhole curve, does not have a skin model and is unable to estimate the required acid coverage and the optimum distance between holes.

U.S. Pat. No. 8,321,190 B2 discloses a system and method for stimulation of a fluid transport for enhancing productivity of a well by introducing an acid in the reservoir rock of the well using a stimulation liner. The stimulation liner is provided with a number of pre-formed holes that form flow passages between the interior of the liner and the annular space around the liner, the so-called “mud cake”. The US patent further describes a method for simulating and/or calculating the distribution of the holes in the stimulation liner to ensure adequate acid coverage in the reservoir rock. The simulation of the location of the holes is done in a trial-and-error analysis by applying a transient model to differentiate between possible locations of the holes in the liner. It is also described that the distribution of the holes can be simulated using a steady-state model.

It is further disclosed in the US patent that the simulation comprises the step of calculating the drop in pressure along the stimulation liner as a dimensionless pressure function or using a polynomial approximation. However, the model disclosed in the US patent does not describe a workflow for design of the optimum hole size distribution. The model does also not estimate the maximum design rate and does not take into account the experimental wormhole curve. The disclosed method does also not consider a physical segmentation of the wellbore with swellable packers. A skin model is also not disclosed in the US patent application.

US Patent Application No. US 2016/245049 A1 discloses an apparatus and method for simulating and/or controlling fluid flow during consecutive injection of a plurality of fluids in a formation and/or in a wellbore. More specifically, the US patent application describes describes the adaptation of a commercial reservoir simulator (Eclipse by Schlumberger) to handle the transient displacement in a wellbore. Numerical modelling is used to determine the conditions and operating parameters required to ensure the best possible distribution of the acid, effective control of the wormhole growth rate in multiple sections of the well, displacement of mud along the entire reservoir section, and handling of significant formation pressure gradients along the reservoir section. A matrix-acid stimulation using a controlled acid jet (CAJ) liner is also disclosed. The US patent application focuses on understanding the pressure response during a well intervention and considers this pressure response to be a key requirement for designing and improving the well intervention job. A workflow for optimizing the hole size distribution is not disclosed. The US patent application directed at capturing the friction reduction (as a function of rate, chemical concentration etc.) as the acid front progresses down through the wellbore.

The teachings of the prior art do not solve the problems presented. For example the assumption of constant friction factor in EP 1 184 537 B1 does not bode well for the actual phenomenon. The authors of EP 1 184 537 B1 have also not laid out design basis for optimum hole size distribution. It cannot estimate maximum design rate and required acid coverage. The work did not incorporate experimental wormhole curves and skin model. U.S. Pat. No. 8,321,190 B2 used a transient model. The teachings also did not describe optimum hole size distribution.

### OBJECT OF THE INVENTION

The invention, which will be described in further detail in subsequent paragraphs, comprises a newly developed method and system for stimulating a well, which addresses, at least partly, the afore-mentioned challenges in a novel and inventive way.

### SUMMARY OF THE INVENTION

It is thus an object of the present invention to provide a system and method for determining the design pump rate of an acid to ensure uniform acid penetration into the reservoir rock of a field while ensuring that the injection pressure remains below a fracturing pressure of the rock. The system and method further provide an accurate and efficient numerical solution strategy for providing an initial estimate of the number of holes per segment which honours the acid coverage per segment and the drop in pressure (dp) across the last one of the holes, in particular in the context of acid stimulation of wells completed in a carbonate reservoir with a Limited-Entry-Liner or LEL liner.

According to a first aspect of the invention the accuracy of simulations of fluid transport of an acid in a system for stimulating a well in a material formation of a resource reservoir can significantly be improved by including a workflow for design of the optimum hole-size distribution. Therefore, optimized hole-size distribution in the liner of a LEL liner system is modelled, which results in an improved modelling accuracy and providing an improved construction and operation of the stimulation system. A well productivity and a use of the acid is enhanced by the improved construction and operation of the stimulation system. In particular, providing an initial estimate of the number of holes per segment of the liner and a cross-sectional area of the holes. The cross-sectional area is based on an optimum velocity for minimizing the amount of acid needed to generate dissolution patterns and a calculated design pump rate for ensuring that an injection pressure remains below a fracturing pressure of the well material formation. The number of holes along the wall of the liner honour the acid coverage per segment and the drop in pressure (dp) across the last one of the holes, wherein the drop in pressure (dp) across the last one of the holes is linearly correlated with the cross-sectional area, such that the initial estimate can be found from the relationship between interstitial velocity, pump rate, and total cross-sectional hole area for a particular discharge coefficient and liner configuration.

According to some embodiments, it is a further object to improve the accuracy of the simulation by ensuring that the annulus pressure remains below fracturing pressure. The maximum allowed pump rate is dictated by the permeability, the fluid viscosity, the length of the completed interval, the skin, and the difference between annulus pressure and reservoir pressure.

According to some embodiments, it is a further objective to improve the accuracy of the simulation by estimating wormholing characteristics to facilitate an optimal hole-size distribution.

The wormholing estimate includes a nodal analysis calculation performed to estimate the downhole temperature at the heel of the liner, and based on the choice of the acid, the permeability and the temperature, the optimum velocity for wormhole propagation is estimated together with the anticipated pore volume to breakthrough.

According to some embodiments, the model accuracy has been improved by providing a method comprising estimation of the total number of holes and drop in pressure (dp) in pressure across the last one of the holes. Based on the optimum velocity and the calculated design pump rate, the total cross-sectional area of the holes is calculated, wherein the area is linearly correlated with the drop in pressure (dp) across the last one of the holes.

According to another aspect, a data processing system is configured to perform the steps of the method described herein.

According to yet another aspect, the invention relates to a method of stimulating a well by means of a workflow system for adjusting the hole-size distribution which honours the acid coverage per segment and the drop in pressure (dp) across the last one of the holes in the context of acid stimulation of wells completed in a carbonate reservoir with a LEL liner. The method comprises:
performing a series of algebraic equations for an initial hole-size distribution guess;
calculating acid coverage and the drop in pressure (dp) across the last one of the holes;
comparing acid coverage and the drop in pressure (dp) across the last one of the holes against design variable in a first iteration;
evenly decreasing the number of holes across a segment for the next iteration until the drop in pressure (dp) across the last one of the holes is honoured; or
evenly increasing the number of holes across a segment for the next iteration until dp across the last one of the holes is honoured, as a first step; and
performing a second step which includes;
redistributing existing number of holes between segments as a first iteration, wherein;
segments, where the calculated acid coverage is the furthest away from design values, exchange one hole;
performing the next iteration until acid coverage is honoured; and
performing the first step and the second step until the drop in pressure (dp) across the last one of the holes and acid coverage is honoured.

According to yet another aspect, the invention relates to a method of stimulating a well by means of a workflow system for adjusting the hole-size distribution which honours the acid coverage per segment and the drop in pressure (dp) across the last one of the holes in the context of acid stimulation of wells completed in a carbonate reservoir with a LEL liner. The method comprises:
running a simulation once the drop in pressure (dp) across the last one of the holes and acid coverage is honoured to determine the wellhead pressure;
adjusting the friction reducer concentration and re-running the simulation if the wellhead pressure exceeds the maximum pressure rating; and/or
increasing a tubing inner diameter (tubing ID) in presence of existing friction reducer; and/or
reducing the pump rate, such that the wellhead pressure rating is maintained below a maximum pressure rating.

According to yet another aspect, the invention relates to a method of stimulating a well by means of a workflow system for adjusting the hole-size distribution which honours the acid coverage per segment and the drop in pressure (dp) across the last one of the holes in the context of acid stimulation of wells completed in a carbonate reservoir with a LEL liner. The method comprises:
running a simulation to determine whether the distance between LEL holes, defined as the length of the stimulate reservoir section divided by the number of holes, should not exceed twice an expected final wormhole radius;
increasing the LEL hole size by 1 mm if the distance between LEL holes is too small, and repeating the simulation; or
decreasing the LEL hole size by 1 mm if the distance between the LEL is too large, and repeating the simulation; or
proceeding with an output of results if the LEL holes is close or equal to twice the wormhole radius.

According to yet another aspect, the method of stimulating a well by means of a workflow system for adjusting the hole-size distribution which honours the acid coverage per segment and the drop in pressure (dp) across the last one of the holes in the context of acid stimulation of wells completed in a carbonate reservoir with a LEL liner in which the constraints of;
annulus pressure exceeding minimum reservoir pressure to avoid cross-flow inside wellbore;
annulus pressure does not exceed fracturing pressure to avoid fracturing;
wellhead pressure does not exceed maximum design pressure rating;
cross-sectional area of all LEL holes combined may be equal to or exceed a minimum cross-sectional area to avoid creating an additional drop in pressure (dp) during normal production or injection of the well after stimulation;
average distance between two neighbouring LEL holes may be equal to twice the wormhole radius; and
liner inner diameter (liner ID) not exceeding the wellbore size, are honoured.

According to yet another aspect, the method of stimulating a well by means of a workflow system for adjusting the hole-size distribution which honours the acid coverage per segment and the drop in pressure (dp) across the last one of the holes in the context of acid stimulation of wells completed in a carbonate reservoir with a LEL liner. The method comprises further:
input of one or more of the following parameters; average reservoir pressure per segment, fracture propagation pressure, permeability per segment, porosity, length of the completed interval, wellbore radius, tubing inner diameter (tubing ID), liner inner diameter (liner ID), pipe roughness, acid properties, number of segments, desired acid coverage per segment, hole size per segment and/or discharge coefficient in a series of algebraic equations for an initial hole-size distribution guess.

According to yet another aspect of the invention, a data processing system is configured to perform the steps of the method of stimulating a well as described herein.

The term data processing system includes any electronic system or device having a processor configured to perform the step of the method, and to communicate the outcome of those steps to a user of the system or device. Such system or device includes, but is not limited to, a computer, a laptop, a handheld electronic device, or electronic workstation.

### BRIEF DESCRIPTION OF THE DRAWINGS

These and other features of the invention will become more apparent by the following description of the embodiment, which is made by way of example, with reference to the accompanying drawings in which:

FIG. 1: shows a schematic cross-sectional view of a well-bore and limited entry liner;

FIG. 2: shows a schematic cross-sectional view of a well-bore which is sectionalized into segments by the use of packers;

FIG. 3: shows a flow diagram, depicting the implementation of the current invention in a step-wise fashion;

FIG. 4: shows a portion of FIG. 3 in greater detail;

FIG. 5: shows, by way of images, the effect of rate on dissolution of an acid, by etching patterns in Texas cream chalk:

FIG. 6: illustrates the impact of interstitial velocity to pore volume to breakthrough;

FIG. 7: illustrates the relation between the temperature of the acid at the entrance of the liner under different pump rates and wellhead temperatures;

FIG. 8: illustrates the volume of acid required to achieve a certain wormhole length based on the pore volume to breakthrough from core flood data;

FIG. 9: illustrates the relationship between the pump rate, the drop in pressure (dp) across the last one of the holes, the discharge coefficient and the total cross-sectional hole area;

FIG. 10: illustrates the effect of Reynold's number on friction factor for different values of pipe roughness;

FIG. 11: illustrates the impact of drag reduction on the friction factor, in a Prandtl-Karman plot;

FIG. 12: illustrates the influence of drag reduction on friction pressure;

FIG. 13: illustrates skin factor as a function of stimulation coverage; and

FIG. 14: illustrates skin factor as a function of a wormhole radius.

### BRIEF DESCRIPTION OF THE PREFERRED EMBODIMENTS

The limited entry liner consists of a number of unevenly spaced holes with the purpose to distribute fluid, in this case acid, evenly along the reservoir section to be stimulated. The concept was initially described in 1963 by Shell for fracturing applications (Lagrone and Rasmussen, 1963) and is still widely applied. It was later adapted for matrix-acid stimulation and patented by Maersk Oil (known as controlled acid jetting or CAJ) and implemented in North Sea chalk reservoirs on a large scale, see Hansen (2001) and Hansen and Nederveen (2002). Since then, this novel stimulation concept has been tested by various operators such as ConocoPhilips (Furui et al., 2010a,b), Petrobras (Fernandes et al., 2006), ExxonMobil (Sau et al., 2014; Troshko et al., 2015), ZADCO (Issa et al., 2014) among others (Mitchell et al., 2014; van Domelen et al., 2011, 2012). Rodrigues et al. (2007) provided a good general overview of stimulation techniques for low-permeability reservoirs and Shokry (2010) described the acid stimulation practice in ADNOC for offshore reservoirs.

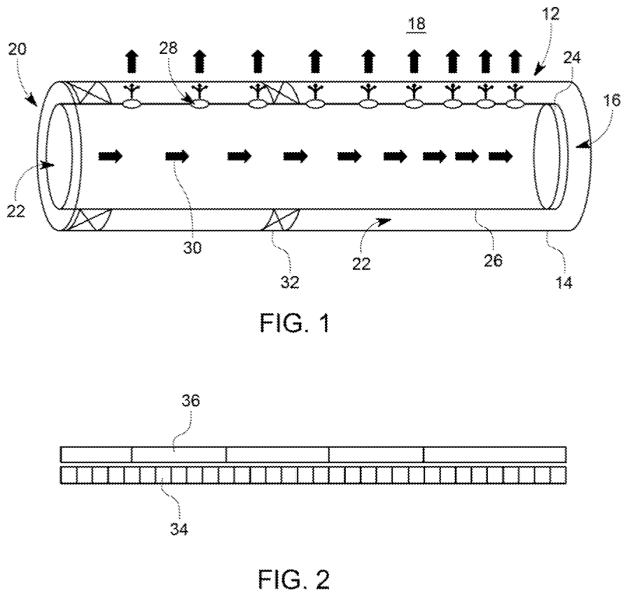

FIG. 1 shows a schematic cross-sectional view of a well-bore 12. The well-bore 12 is conventionally formed by techniques commonly known in the art and includes a wall 14 created by the drilling process, a leading end 16, which extends into the formation 18, and a trailing end 20 for accessing the well-bore.

A limited entry liner 20 is introduced into the well-bore 12. The liner 20 has an open end 22 and opposed sealed end 24. An annulus 22 is formed between the wall 14 and outer surface 26 of the liner.

The liner 20 is provided with a number of pre-formed holes 28 that form flow passages between the interior of the liner 20 and the annular space 22. The holes 28 have a shape and location that comply with particular, pre-defined specifications.

Typically, the distances between adjacent holes 28 along the liner 20 decrease towards the end 24 of the liner.

The acid is pumped into the liner in the liner 20 and exits holes 28 at high velocities resulting in jetting into the formation 18. By limiting the number and size of holes, a choke effect is obtained and a significant drop in pressure (dp) occurs between the inside and the outside of the liner during stimulation. A non-uniform geometric distribution of the holes is used to compensate for the friction drop in pressure (dp) along the liner section. This means that the average hole spacing decreases towards the bottom of the liner. The open annulus 22 outside the liner in combination with the overpressure on the inside of the liner (due to the choking over the holes) ensures that the acid eventually reaches the bottom of liner, and the well is thus stimulated along its full length.

Acid is bull-headed from the surface and enters the liner 20 in the direction of arrows 30. The liner does not have to be horizontal but very often is. When acid reaches the first hole 28, which has a size of 2-7 mm, the drop in pressure (dp) across the hole is so high that only a small portion of the acid exits the liner through the hole; the remaining portion continues along the liner until it reaches the next hole where the same process is repeated. An appropriate hole-size design makes it possible to honour a specified acid coverage, defined as barrels of acid per feet of reservoir section. Prior to the stimulation, the mud can be circulated out so that only completion brine with the right density is found in the wellbore 12.

The acid stimulation process is modelled by discretizing the wellbore 12 into a number of nodes 34, typically 100-400. The nodes do not need to have the same size. From a practical design point of view, the wellbore is split into a smaller number of segments 36. These segments may be physically isolated from each other on the annulus side by hydraulic packers 32 (not shown) but do not have to. Nodes can overlap between two segments, as shown in FIG. 2.

Displacement of brine by acid is considered to occur by single-phase plug flow with minimal dispersion. The negative excess mixing volume is not taken into account. The liner 20 is closed at sealed end 24 before stimulation and it is not cemented, which means that fluid can in principle flow in the annulus 22 along the well-bore trajectory before packers 32 are set. In practice, annulus flow occurs predominantly due to jetting of acid through the holes 28, perpendicular to the wellbore. Annulus flow along the liner can be ignored for practical modelling purposes.

The completion design, and the associated modelling workflow covered in this document, allows for reservoir segmentation using packers and the resulting liner is hence referred to as a segmented limited entry liner. The desired acid coverage can be specified per segment to take into account differences in porosity, permeability, initial water saturation, and reservoir pressure. The number of segments for modelling the process can be larger than the number of packer-isolated intervals.

Design of the hole-size distribution depends primarily on liner geometry and flow rate, which in turn is governed by reservoir properties, i.e. reservoir permeability. Acid stimulation is inherently transient in nature because the skin factor at any given position along the well changes with time from a positive value initially (caused by a mud filter cake) towards a negative value once the acid has reacted with the reservoir rock minerals. This reacting of the acid with the reservoir rock minerals leads to the formation of highly conductive fluid flow paths in the reservoir rock. These fluid flow paths are commonly referred to as “wormholes”. These wormholes are desired in the stimulation process of the reservoir rock because they allow the acid to propagate further into the reservoir rock, thereby enabling the flow of the subsurface hydrocarbons along these wormholes once the acid is spent. If the skin evolution over time is uniform along the well, it will not affect the flow distribution, which means that the overall process can be modelled based on steady-state principles.

The invention consists of a comprehensive algorithm for designing the hole-size distribution for limited entry liners. The next sections describe the algorithm for designing a hole-size distribution which achieves a specified (often uniform) distribution of acid volume per interval length, also known as acid coverage.

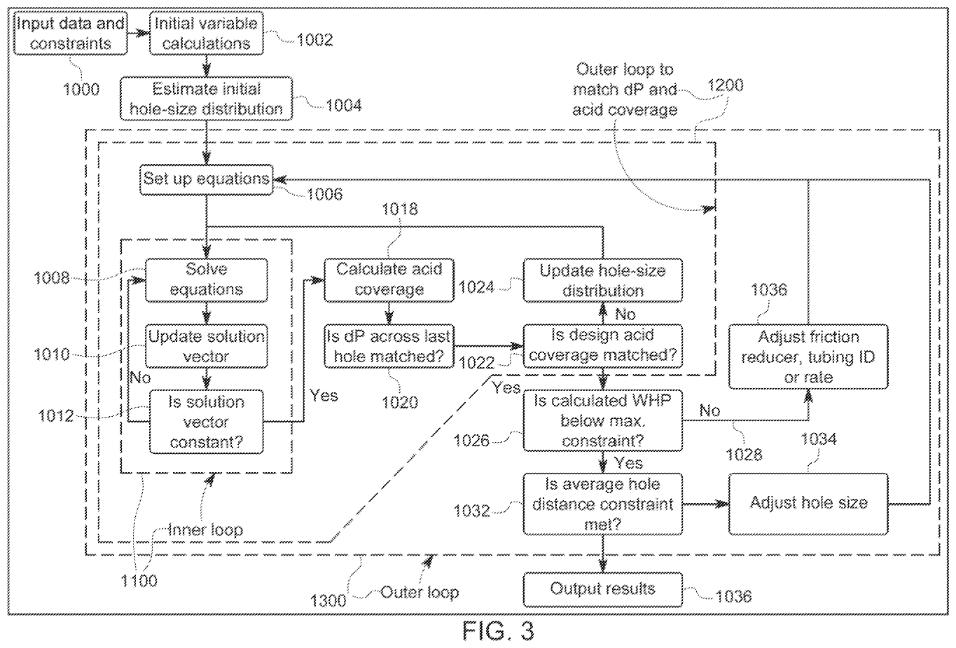

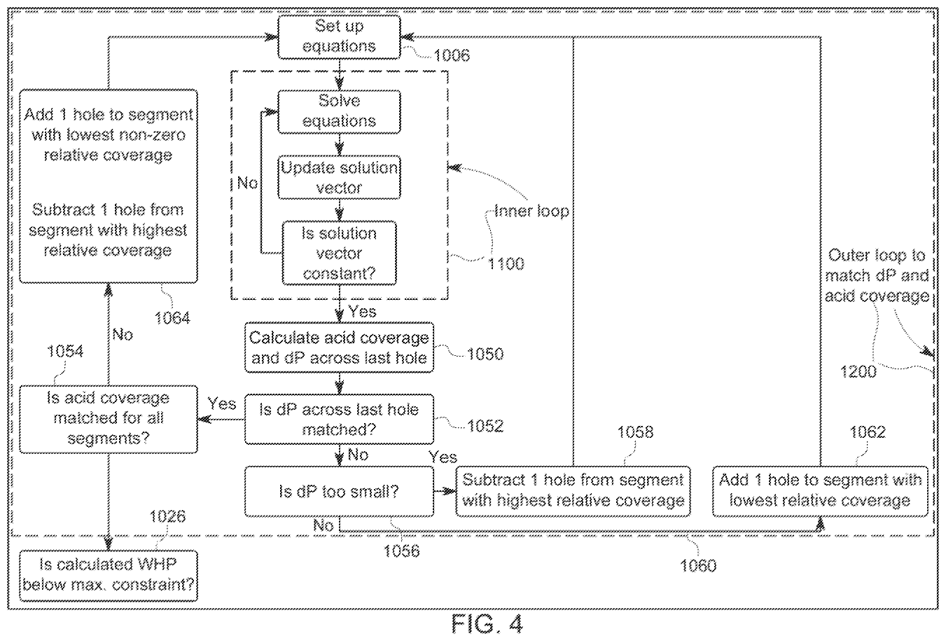

The algorithm is shown schematically in FIGS. 3 and 4. FIG. 3 shows the overall algorithm whereas FIG. 4 shows a more detailed part of FIG. 3. The algorithm is discussed by reference now to FIG. 3 and the first block, input data and constraints 1000.

Input data and constraints 1000:

As a starting point for implementation of the algorithm, input data constraints are entered into the system. The input data is made up of rock properties, completion data, fluid properties and other data, such as pump rate, number of nodes for the numerical algorithm, drop in pressure (dp) across the last one of the holes of the liner, and annulus pressure. These inputs are either known or may be sourced from historical data from the wellbore.

The algorithm defines certain constraints which must be adhered to in the functioning of the system. These constraints form part of the input data and constraints 1000. The constraints includes, but are not limited to; annulus pressure must exceed minimum reservoir pressure to avoid cross-flow inside wellbore; annulus pressure must not exceed fracturing pressure to avoid fracturing; wellhead pressure must not exceed maximum design pressure rating—in turn this impacts the design rate and/or the amount of friction reducer to be added; cross-sectional area of all LEL holes combined should be equal to or exceed a minimum cross-sectional area to avoid creating an additional drop in pressure (dp) during normal production or injection of the well after stimulation—this impacts the number and size of the holes; average distance between two neighbouring LEL holes should equal twice a radius of the wormholes formed along the limited entry liner—this impacts the drop in pressure (dp) across the last LEL hole which is a design variable; and, the liner inner diameter (liner ID) cannot exceed the wellbore size.

Moving on to the next step, as shown in FIG. 3 block 1002

Initial variable calculations 1002:

Based on the input per segment, the maximum rate per segment is found by applying the transient inflow equation. Note that although the well is horizontal, it acts as a vertical well in the early injection phase because the boundaries have not been felt. Hence, the reservoir section length, L, replaces the reservoir thickness, H.

$${Q}_{i} = \frac{{P}_{s t i m} - {P}_{res , i}}{1440} \times \frac{{k}_{l} \times {L}_{1}}{162.6 \times {μ}_{max} \times {B}_{a c i d} \times [ {log}_{10} ( {ε}_{i} \times T ) - 3.23 + 0.87 \times {S}_{i} ]} \qquad Equation 1$$

B is the acid formation volume factor, which is in the range 1.0 to 1.1. In practice, it is assumed to be 1. The viscosity is the maximum value of the oil or gas viscosity and the acid viscosity. In heavy oil reservoirs, the transient phase injectivity is initially controlled by the oil properties. Thus,

μₘₐₓ=max(μₒ,μ_{acid}) Equation 2

The permeability will see a contribution from the two horizontal directions as well as the vertical direction:

$${k}_{i} = \sqrt[3]{{k}_{x , i} {k}_{y , i} {k}_{z , i}} \qquad Equation 3$$

The vertical/horizontal permeability ratio may attain values in the range 0.01 to 1.0. For the current application, the value is close to 1, which makes the overall permeability equal to the horizontal permeability.

The diffusivity is given as

$${ε}_{i} = \frac{{k}_{i}}{φ \times {μ}_{max} \times {c}_{t o t} \times {r}_{w}^{2}} \qquad Equation 4$$

Where the total system compressibility is given as a contribution from the rock and the fluid phases present in the pore space.

cₜₒₜ=c_{rock}+S_{w}×c_{w}(1−S_{w})×cₒ Equation 5

rw refers to the wellbore radius. In gas reservoirs, co equals gas compressibility.

The maximum pump rate allowed is then the sum of the individual segment rates:

Q=ΣᵢⁿQᵢ Equation 6

However, any segments which must be left unstimulated and therefore require joints without holes, do not contribute to the calculation of the total rate. To start the design algorithm detailed later, the actual design rate is taken as a value 10-30% lower than the maximum allowed rate. This value may be adjusted in a subsequent iteration.

T is the total pump time calculated from the acid coverage and length of all the segments

$$T = \frac{{\sum }_{i}^{n} {C}_{a cid , i} \times {L}_{i}}{{Q}_{design}} \qquad Equation 7$$

It is noted that T depends on Q, which depends on T.

Research into matrix-acid stimulation fundamentals took off in the 1980's with the pioneering work of Fogler and co-workers from the University of Michigan (Hoefner et al., 1987; Hoefner and Fogler, 1989; Bernadiner et al., 1992; Fredd and Fogler, 1996, 1997, 1999; Fredd et al., 1997) who demonstrated that the acid reaction with the rock gives rise to different etching patterns depending on the type and concentration of acid as well as the velocity and the temperature. Key subsequent contributions in the literature to the current understanding includes work by Halliburton (Gdanski and Norman, 1986; Gdanski and van Domelen, 1999; Gdanski, 1999), Buijse and Glasbergen (2005), and Hill and coworkers from Texas A&M University (Al-Ghamdi et al., 2014; Dong et al., 2014, 2016; Dubetz et al., 2016; Etten et al., 2015; Furui et al., 2005, 2008, 2010a,b; Izgec et al., 2008; Ndonhong et al., 2016, 2018; Sasongko et al., 2011; Schwalbert et al., 2018; Shirley et al., 2017; Shukla et al., 2006). Further references to experimental and theoretical studies on wormhole growth are listed within these references.

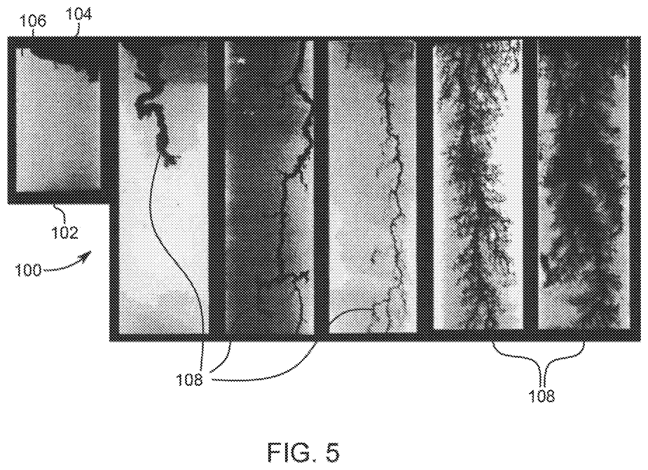

FIG. 5 shows the effect of rate on dissolution through a series of images 100. A low rate leads to uniform dissolution and hence a very inefficient usage of the acid. This is shown by the image to the far left 102. In the image the acid 104 has not permeated the formation 106 to any appreciable extent. At slightly higher rates (i.e. moving from left to right in the images), the acid creates wormholes 108 through the rock. In fact, any acid formulation has an optimum velocity at which the least volume of acid is required to etch a pattern from inlet to outlet. This volume is called the pore volume to breakthrough 202. Note that 15% HCl corresponds to 4.4 M, hence the 0.5 M concentration used in the experiment is quite low.

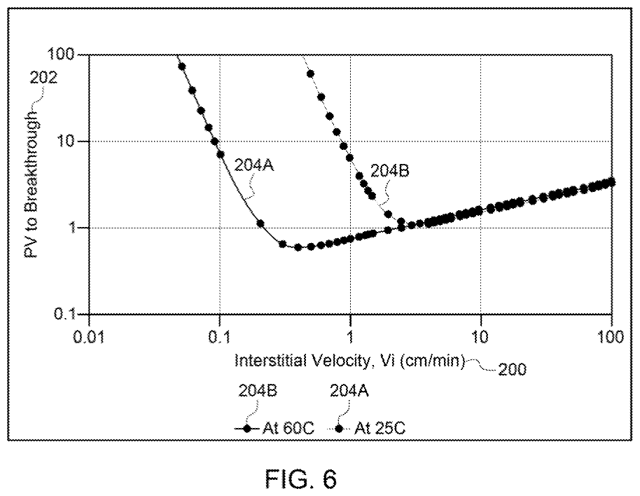

FIG. 6 illustrates the impact of interstitial velocity 200 on pore volume to breakthrough 202 at two different temperatures 204A (depicted by the dot-dash line) and 204B (depicted by the solid line). A temperature increase (i.e. from temperature 204A at 25° C. to temperature 204B at 600 C) leads to higher reaction rate and hence faster dissolution; optimum wormhole growth therefore requires a higher acid velocity to avoid spending all the acid near the wellbore. It is also clear that it is better to pump at a rate which is slightly above the optimal than below. In a low-permeability reservoir, the maximum pump rate is limited by the fracturing pressure, which may prevent the operator from reaching the optimum velocity. In such situations, it is necessary to select a different acid 104 formulation to shift the curve to the left and preferably also down.

The wormhole data can be reproduced with a model proposed by Buijse and Glasbergen (2005) containing two fitting constants, α and β, which can be reformulated in terms of the lowest point on the curve (optimum interstitial velocity 200, optimum pore volume to breakthrough 202)

$$P {V}_{bt} = \frac{{v}_{int , i}^{\frac{1}{3}}}{α \times {[ 1 - exp ( - β {v}_{i n t , i}^{2} ) ]}^{2}} \qquad Equation 8$$

Increased temperature 204 and increased HCl concentration both increase the optimum velocity 200 for wormholing. For low-permeability rocks where the optimum rate may be limited by the fracture propagation pressure, it may be beneficial to reduce the acid concentration, although the pore volume to breakthrough 202 increases and hence the volume of acid solution needed. If the acid concentration is halved then the volume must double to maintain the same number of moles. Several authors have investigated the effect of weaker acids, see Punnapala et al. (2014) and Shirley et al. (2014). A friction reducer may shift the PV curve upwards, which means that more acid is required to achieve the same skin.

Talbot and Gdanski (2008) proposed a general wormhole model where they correlate the two input parameters to the Buijse-Glasbergen model as a function of rock and acid properties as well as temperature. However, they do not specify the values of the constants in their correlation.

In this invention, we make use of a concept whereby we shift the default wormhole curve shown in FIG. 6 up, down, left, or right as a function of the temperature 204, the permeability, and the acid type. Table 1 shows some rough rules-of-thumb when adjusting the optimum (lowest) point on the wormhole curve. Based on the default curve, the optimum point is shifted with the amount indicated. The optimum point cannot be lower than (0.1, 0.1). Values in the table are only indicative and serve to illustrate a concept.

TABLE 1
Optimum Wormhole growth parameters

| | | | | HCl Conc | PVbt, | Vi, |
|---|---|---|---|---|---|---|
| Case | T (F.) | K (mD) | | (%) | opt (y) | opt (x) |
| Default | 70 | 5-20 | mD | 15 | 1.0 | 1.0 |
| High | 70 | >20 | mD | 15 | Add 0.5 | Add 1.0 |
| permeability | | | | | | |
| Low | 70 | <5 | mD | 15 | Subtract | Keep |
| permeability | | | | | 0.5 | |
| Medium | 70-200 | 1-20 | mD | 15 | Add 0.5 | Add 1.0 |
| temperature | | | | | | |
| High | >200 | 1-20 | mD | 15 | Add 0.5 | Add 2.0 |
| temperature | | | | | | |
| Strong acid | 70 | 1-20 | mD | 20-28 | Subtract | Add 0.5 |
| | | | | | 0.5 | |
| Weak acid | 70 | 1-20 | mD | 5-10 | Add 0.5 | Subtract |
| | | | | | | 0.5 |

Acid reactivity increases with temperature 204, which means that the optimum velocity 200 for wormhole growth also increases. For low-permeability reservoirs, it can be difficult to reach the optimum velocity without fracturing the formation. Therefore, it is important to evaluate the downhole temperature of the acid 104 when it reaches the formation 106.

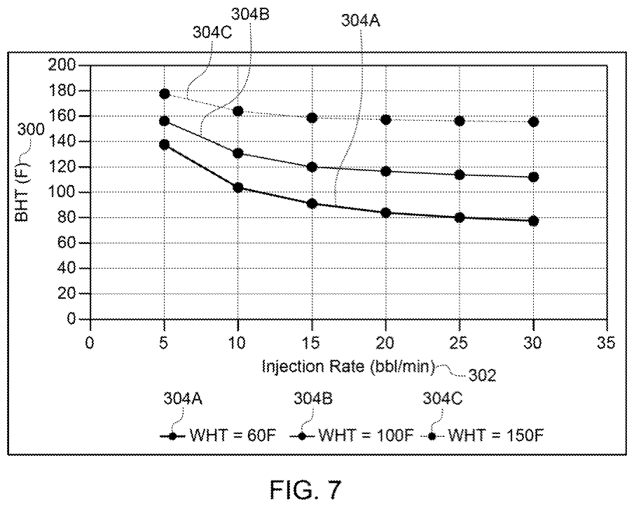

As shown in FIG. 7, which illustrates the relation between the temperature of the acid at the entrance of the liner 300 under different pump rates 302 and wellhead temperatures 304. It is an advantage to inject at high rate and at the lowest possible wellhead temperature to limit the in-situ acid reactivity. This is shown by line 304A. As the temperature increases, lines 304B, and 304C we can see an increase in the acid reactivity at the entrance of the liner 300. Furthermore, any brine used to clean out the mud prior to the acid stimulation should be injected at the lowest possible temperature.

The temperature to be used for adjusting the wormhole curve is the temperature of the acid when it enters the reservoir, not the reservoir temperature.

Economides et al. (1994) derived a formula to determine the volume of acid required to achieve a certain wormhole length 400 based on the pore volume to breakthrough 202 from core flood data:

$${r}_{w h} = \sqrt{{r}_{w}^{2} + \frac{5.615 V}{πφ {LPV}_{b t}}} = \sqrt{{r}_{w}^{2} + \frac{5.615 \times COV}{πφ {PV}_{b t}}} \qquad Equation 9$$

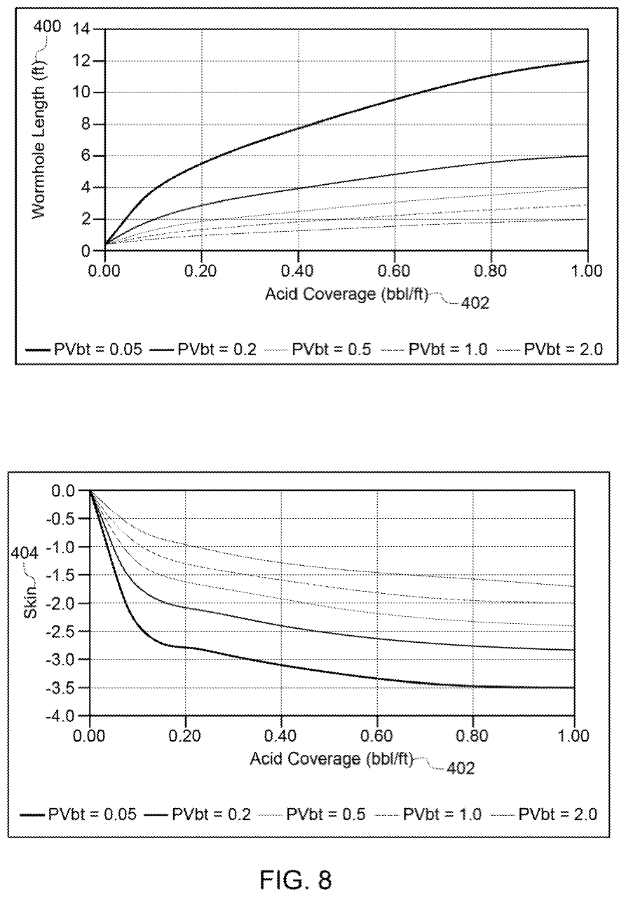

The formula is plotted in FIG. 8. The ratio V/L is known as the acid coverage in bbl/ft 402. The equivalent skin 404 is given as:

$$S = ln \frac{{r}_{w}}{{r}_{w h}}$$

The algorithm aims to achieve a given final skin factor and then calculates the equivalent wormhole radius and then the required acid coverage. However, for economic considerations, the maximum acid coverage is limited by the acid volume which can be pumped. For instance, in offshore wells, the volume is limited by acid boat capacity. In the current application, the acid coverage should not exceed 1.5 bbl/ft.

Alternatively, the acid stimulation can be fixed, which enables calculation of the maximum, final wormhole length 400 and consequently the final, negative skin 404.

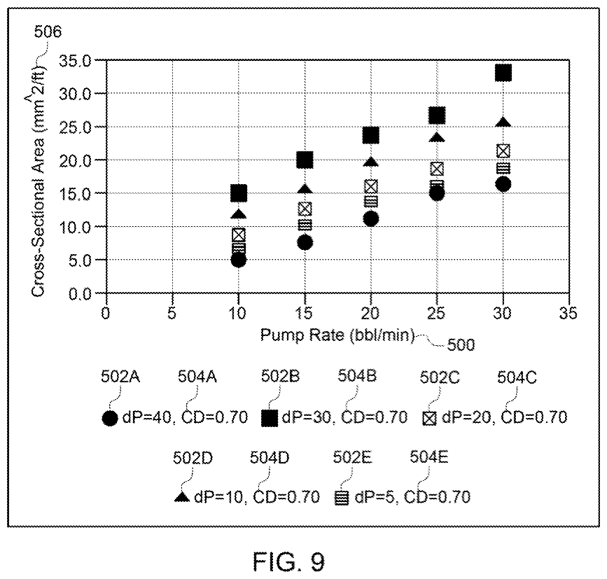

FIG. 9 illustrates the outcome of a larger sensitivity analysis involving a pump rate 500, the drop in pressure (dp) across the last one of the holes 502 (502A to 502E, respectively), a discharge coefficient (CD) 504 (504A to 504E, respectively) and the total hole cross-sectional hole area 506. The linear relationship between the total hole cross-sectional hole area 506 and the pump rate 500 is derived from the sensitivity analysis. It is therefore possible to predict the drop in pressure (dp) 502 required to obtain a certain total hole cross-sectional hole area 506. This constraint that the total hole cross-sectional hole area 506 must be equal to or larger than a minimum cross-sectional area to avoid imposing an additional drop in pressure (dp) 502 during production/injection after stimulation therefore results in a constraint on the drop in pressure (dp) 502 across the last one of the holes, which can be estimated based on the relationship provided by the sensitivity analysis. This is a novel concept.

Where;

A=aQ+b Equation 10

a=αdP+β Equation 11

b=γdP+δ Equation 12

At this stage, we are able to estimate the initial hole-size distribution for the starting point of the algorithm. This is depicted by block 1004 in FIG. 3.

The next step, block 1006, requires that the equations are set up. These are then solved as part of the following step, block 1008, dealt with later in this specification.

### Set Up Equations 1004:

The equation of motion for isothermal one-dimensional pipe flow describes the drop in pressure (dp) as a contribution from friction, gravity, and acceleration. The gravity term dominates in the vertical section of the wellbore, whereas friction losses become relatively more important in the horizontal section. The acceleration term is only required when velocity changes occur, such as when fluid enters the liner from the tubing (change in inner diameter), or whenever fluid exits through a hole in the liner. The contribution of the acceleration term to the total drop in pressure (dp) is less than 5% and can often be neglected.

$$\frac{dP}{dx} = - \frac{{dP}_{fric}}{dx} - \frac{{dP}_{a c c}}{dx} - \frac{{dP}_{grav}}{dx} \qquad Equation 13$$

$$\frac{dP}{dx} = - \frac{4 {τ}_{w}}{D} - ρ v \frac{dv}{dx} - ρ g cos θ \qquad Equation 14$$

θ is the angle relative to the z-axis and D is the pipe diameter. The acceleration term can be expressed in terms of volumetric flow Q instead of velocity v,

$$\frac{{dP}_{a c c}}{dx} = - {ρ [ \frac{4}{π {D}^{2}} ]}^{2} Q \frac{dQ}{dx} \qquad Equation 15$$

The Fanning friction factor, f, is defined in terms of the wall shear stress

$${τ}_{w} = f \frac{ρ {v}^{2}}{2} \qquad Equation 17$$

Hence the friction drop in pressure (dp_{fric}) for Newtonian flow is:

$$\frac{{dP}_{fric}}{dx} = - \frac{4 f}{D} \frac{ρ {v}^{2}}{2} \qquad Equation 18$$

For laminar flow the Fanning friction factor is linked to the Reynolds number,

$$f = \frac{16}{Re} \qquad Equation 20$$

The Reynolds number is given as

$$Re = 15916 \frac{ρ Q}{D μ} \qquad Equation 21$$

The pressure difference due to the static head is found from:

$$\frac{{dP}_{grav}}{dx} = 0.052 ρ cos θ \qquad Equation 27$$

The Fanning friction factor for pipe flow in smooth pipes is described by the Prandtl-Karman equation:

$$\sqrt{\frac{1}{f}} = 4 {log}_{10} ( Re \sqrt{f} ) - 0.4 = - 4 {log}_{10} \frac{1.26}{Re \sqrt{f}} \qquad Equation 28$$

For rough pipes, the friction factor depends on the relative pipe roughness, c/D, and is given as

$$\sqrt{\frac{1}{f}} = 4 {log}_{10} ( Re \sqrt{f} ) - 0.4 = - 4 {log}_{10} [ \frac{1.26}{Re \sqrt{f}} + \frac{ε}{3.7 D} ] \qquad Equation 29$$

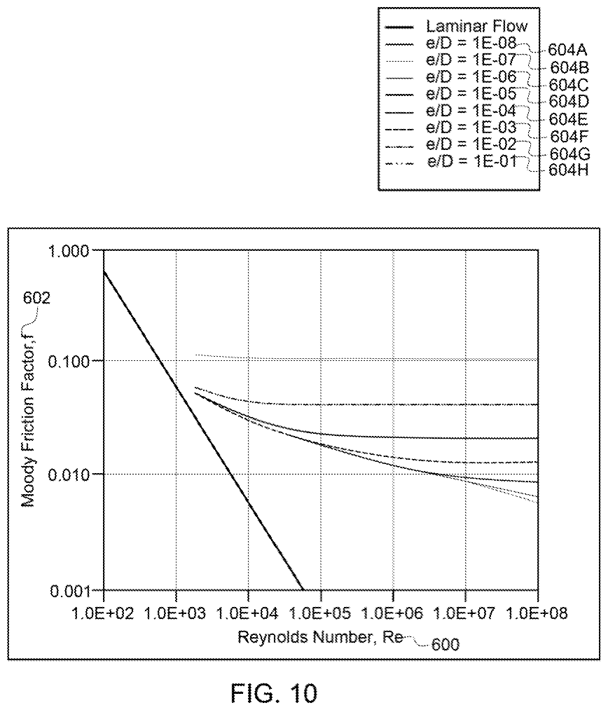

FIG. 10 illustrates the effect of Reynold's number 600 on friction factor 602 for different values of pipe roughness 604 (604A to 604H, respectively). A typical relative roughness for a new pipe is 10-4.

There is a potential discontinuity going from laminar to turbulent flow because the flow regime is poorly defined in the 1000-2000 Reynolds number region. This has no impact on the LEL hole design. FIG. 10 shows that roughness plays a role only if it exceeds 0.0001.

Typical pumping rates are 5-40 bbl/min, depending on reservoir permeability and liner length. Such rates may lead to high surface pressures and thus require the upper completion to be designed appropriately. There is often a need to reduce the friction pressure loss to stay within safe operating limits and this requirement may necessitate the use of drag reducing agents (DRA). Drag reducers are mostly dilute polymer solutions, which lower the frictional resistance to flow in the turbulent regime when added to a solvent, for instance water or acid. Very low concentrations (a few thousand ppm) may in some instances reduce friction by as much as 70%. Friction reducers, may, however, cause reservoir damage, according to some studies.

When adding drag reducing agents a zone named the elastic sub-layer is formed between the viscous sub-layer and the Newtonian core. The extent of the elastic sub-layer will be governed by the amount and type of polymer, and by the flow rate.

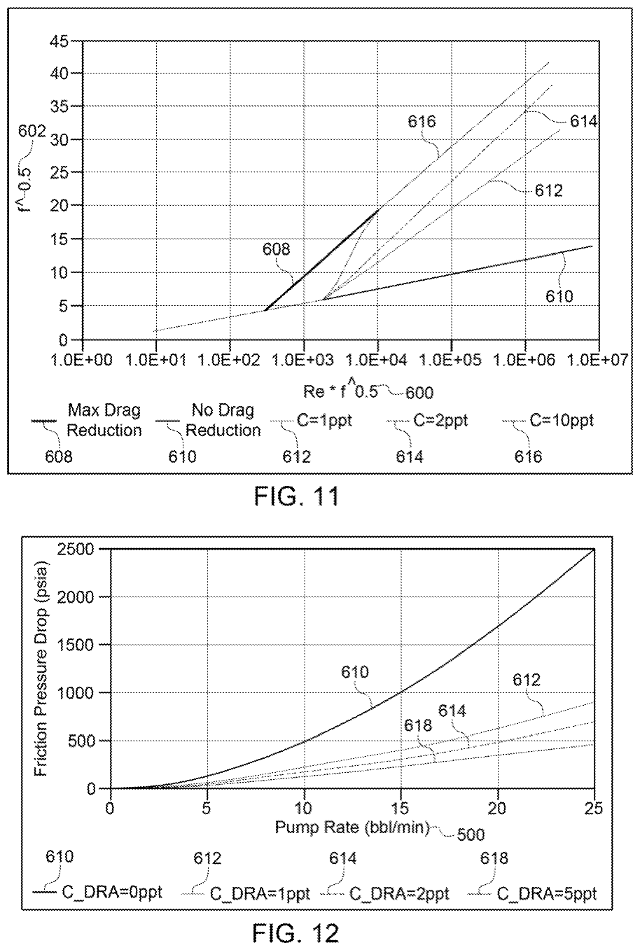

Maximum drag reduction is achieved when the elastic sub-layer extends to occupy the entire pipe cross-section. Drag reduction by dilute polymer solutions in turbulent pipe flow is bounded between the two universal asymptotes described by Newtonian turbulent flow and a maximum drag reduction asymptote. In between is the so-called polymeric regime in which the friction factor relations are approximately linear in Prandtl-Karman coordinates, see FIG. 11. The polymeric regime may be described by two parameters: The onset wave number w* and the slope increment, δ, by which the polymer solution slope exceeds Newtonian slope. The onset of drag reduction occurs at a well defined onset wave number. For a given polymer solution w* is essentially the same for different pipe diameters. For solutions of a given polymer-solvent combination w* is approximately independent of polymer concentration.

When modelling the effect of the drag reducer, it is assumed that the fluid friction factor is reduced and that the fluid viscosity remains the same. Acid viscosity, via the Reynolds number, has a minor impact on friction losses at typical operating conditions, as seen from FIG. 10.

The following formula, developed by Virk (1971, 1975) relates the friction factor to the concentration of the drag reducer for pipe flow:

$$\sqrt{\frac{1}{f}} = ( 4 + δ ) {log}_{10} ( Re \sqrt{f} ) - 0.4 - δ {log}_{10} [ \sqrt{2} {Dw}^{*} ] \qquad Equation 32$$

The drag reduction model parameters are

δ=kC_{DRA}^{α} Equation 33

K and a are constants. The parameters are specific to the chemical used and must be fitted based on flow loop test data provided by the vendor.

The maximum drag reduction asymptote for pipe flow is described by:

$$\sqrt{\frac{1}{f}} = 19 {log}_{10} ( Re \sqrt{f} ) - 32.4 \qquad Equation 34$$

FIG. 11 shows the impact of drag reduction on the friction factor, in a Prandtl-Karman plot.

For the particular Drag Reducing Agent (DRA) 606 model constants used, the maximum asymptote 608 is only reached if the DRA concentration exceeds 2000 ppm.

Without the addition of a DRA is shown by 610. Incrementally increasing the amount of DRA is shown by lines 612, 614 and 616 respectively.

In a 6″ inner diameter (ID) liner, a pumping rate of 25 bbl/min, equivalent of 36000 bbl/d, leads to a Reynolds number of approximately 321635, which is well inside the turbulent flow regime.

FIG. 12 illustrates the influence of drag reduction on friction pressure 620 in a 10000 ft long 4.5″ OD top completion string as a function of pump rate 500. Friction is reduced to ⅓ by adding 1000 ppm DRA. The concentration of DRA is similar to that as illustrated in FIG. 11.

The limited entry liner consists of a number of holes allowing fluid to exit the liner and enter the annulus and subsequently the reservoir. The holes are small compared to the liner dimensions, both in terms of length and diameter and can therefore be considered as an orifice. The drop in pressure (dpₕₒₗₑ) across N holes in the liner may be calculated as:

$$Δ {P}_{hole} = - \frac{0.2369 ρ {Q}_{hole}^{2}}{{[ {NC}_{D} {D}_{hole}^{2} ]}^{2}} \qquad Equation 35$$

Qₕₒₗₑ is the flow rate in bbl/min through the holes. The positive direction is from the liner and into the annulus. Dₕₒₗₑ is the inner diameter, in inches, of the holes in the liner. N is the total number of holes. CD is the dimensionless discharge coefficient, which accounts for the fact that the pressure loss is only partially recovered due to the short length of the hole (equal to the pipe thickness). Based on the work by Crump and Conway (1988), a lower value of 0.56 is used for flow of water and gelled fluids in round sharp-edged drilled holes; values up to 0.90 are also possible, depending on fluid type and how the hole was actually drilled, see El-Rabba et al. (1997) and McLemore et al. (2013). CD should be considered a sensitivity variable during the first LEL design jobs. Drilling the holes at a slight angle may reduce the splash-back of unspent acid hitting the formation and improve the jetting process.

The model for the friction factor in the presence of a drag reducer is combined with the model for the friction factor for Newtonian turbulent pipe flow in rough pipes.

$$\sqrt{\frac{1}{f}} = - 4 {log}_{10} [ \frac{1.26}{Re \sqrt{f}} + \frac{ε}{3.7 D} ] + δ {log}_{10} [ \frac{Re \sqrt{f}}{\sqrt{2} {Dw}^{*}} ] \qquad Equation 36$$

If no drag reducers are used then 6=0. If drag reducers are used the roughness is set to zero.

Inserting the expression for Reynolds number:

$$\sqrt{\frac{1}{f}} = - 4 {log}_{10} [ \frac{1.26 D μ}{15916 ρ Q \sqrt{f}} + \frac{ε}{3.7 D} ] + δ {log}_{10} [ \frac{15916 ρ Q \sqrt{f}}{D μ \sqrt{2} {Dw}^{*}} ] \qquad Equation 37$$

The flow between adjacent cells in the LEL is now fully described and gives rise to a set of non-linear equations, which can be solved using standard mathematical techniques, such as finite-difference and others.

The algorithm enters into the inner loop 1100. This lead by block 1008, Solve equations.

The final step of the inner loop 1100 is to determine whether the solution vector is constant, block 1012.

### Is Solution Vector Constant 1012:

Typically, the Newton-Raphson technique will converge within 5 iterations using carefully selected relaxation parameters to guide the convergence during the first iterations. The method ensures that final convergence speed is quadratic.

The iterative inner loop will repeat by following arrow 1014, and restating resolving the equations, as set forth from block 1008.

This iterative inner loop 1100 finishes when the absolute change to the solution vector is below a certain threshold value, typically 1E-12. To avoid the possibility of an infinite loop, the procedure stops after a pre-specified number of iterations has been reached, typically in the range 10-20.

Once the solution vector is deemed constant, the next step is to follow arrow 1016 to calculate the acid coverage, depicted by block 1018.

### Calculate Acid Coverage 1018:

Once the stimulation flow rates are calculated from the solution, the acid coverage per liner segment is the product of segment flow rate and pumping time. If the overall pump rate changes during the job, the stimulation rate for each segment changes.

C_{acid,i}=Q_{stim,i}×T Equation 97

The transient period where the acid front moves through along the liner while displacing the brine must also be taken into account. However, this is compensated for when water displaces acid at the end of the job. The time it takes for the front to reach a given position i, is called the retention time, which is calculated recursively:

$${t}_{i} = {t}_{i - 1} + \frac{{V}_{liner , i}}{{Q}_{liner , i}} \qquad Equation 98$$

Since the liner flow rate gradually decreases towards zero at the heel, it is clear that it takes gradually longer time for the acid front to displace the brine out of the liner. In other words, the inner part sees acid for longer time than the outer part. The hole-size distribution should compensate for this. The retention time is therefore also a measure of the minimum time needed for water to displace acid from the liner at the end of the stimulation.

The next step is shown in block 1020, to determine if the drop in pressure (dp) across the last one of the holes is matched. This step goes in combination with the following block 1022 which is to determine if design acid coverage is matched.

### Is the Drop in Pressure (Dp) Across the Last One of the Holes Matched 1020?:

The drop in pressure (dp) across the last one of the holes is calculated as the difference between the pressure in the last node of the liner and the annulus stimulation pressure (which is constant and user-specified):

dP_{last hole}=P_{liner,n}−Pₛₜᵢₘ Equation 99

Is design acid coverage matched 1022?:

The difference between calculated and specified target acid coverage is given as

dCOV=Σᵢ₌₁^{segments}|COV_{i,calc}−COV_{i,target}| Equation 100

This formulation ensures that the dCOV (acid coverage distribution) function is always positive. Hence, it must be minimized to obtain the best possible match. The relative acid coverage is determined as follows:

$${R}_{cov , i} = \frac{{COV}_{i , calc}}{{COV}_{i , target}} if {COV}_{i , calc} > 0 \qquad Equation 101$$

Turning to FIG. 4, the above two steps are combined into block 1050.

Whereas the inner loop 1100 consists of solving the material balance for a given combination of LEL holes, pump rate and other variables, the first part of the outer loop 1200 consists of adjusting the LEL hole size distribution to match both the desired drop in pressure (dp) across the last one of the holes, drop in pressure (dp) 1052, and the desired acid coverage for each segment 1054. The outer loop 1200 serves to honour both constraints at the same time.

Therefore, the hole size-distribution must be satisfied, as shown in block 1024

### Update Hole-Size Distribution 1024:

If the drop in pressure (dp) is too small 1056, then there are too many LEL holes and one LEL hole is then subtracted from the segment with the highest relative acid coverage 1058 and the material balance inner loop 1100, via block 1006, is then reinvoked.

If the drop in pressure (dp) is too large (arrow 1060), there are too few holes, and one hole is then added to the segment with the lowest, non-zero relative acid coverage 1062 and the material balance inner loop 1100, via block 1006, is reinvoked

Segments with zero acid coverage are not adjusted.

If the drop in pressure (dp) is close to the target value within a certain tolerance, then the acid coverage distribution dCOV is calculated 1054. At this point, the total number of LEL holes is correct but the holes just need to be redistributed among segments. One LEL hole is added to the segment with the lowest, non-zero relative acid coverage, whereas one LEL hole is subtracted from the segment with the highest relative acid coverage 1064. Then the inner loop 1100, via block 1006, is reinvoked and the procedure is repeated until the dCOV function reaches a minimum. Since the algorithm adjusts integer values, i.e. number of LEL holes, it is not possible for the dCOV function to be exactly zero.

Once the minimum dCOV function is reached, it must be determined if the calculated wellhead pressure (WHP) is below the wellhead pressure maximum constraint, as shown in block 1026.

Is Calculated WHP Below Max. Constraint?:

Every wellhead has a maximum pressure rating, such as 5000 psia, 6500 psia and higher. Similarly, every tubing has a maximum pressure rating. Therefore, if the reservoir pressure is high, the design rate may give rise to a wellhead pressure, which exceeds the pressure rating.

If the calculated wellhead pressure exceeds the maximum rating of the tubing (shown by arrow 1028), adjustment to the design (block 1030) requires the following steps:

Step 1: If the previous design was based on zero friction reduction, then add 2000 ppm friction reducer. Re-run the simulation.

Step 2: If friction reducer is already present, investigate the possibility to increase the tubing inner diameter (tubing ID). Re-run the simulation.

Step 3: If step 2 is not possible, reduce the rate, re-run the simulation, and loop until the calculated WHP is below the maximum pressure rating of the tubing.

Next, the average hole distance constraint must be met, block 1032.

### Is Average Hole Constraint Met?:

As described earlier, Economides et al. (1994) derived a formula to determine the volume of acid required to achieve a certain wormhole length based on the pore volume to breakthrough from core flood data:

$${r}_{wh} = \sqrt{{r}_{w}^{2} + \frac{5.615 V}{πφ {LPV}_{bt}}} = \sqrt{{r}_{w}^{2} + \frac{5.615 \times COV}{πφ {PV}_{bt}}} \qquad Equation 102$$

The ratio V/L is known as the acid coverage in bbl/ft. The equivalent skin is given as

$$S = ln \frac{{r}_{w}}{{r}_{wh}} \qquad Equation 103$$

Schwalbert et al. (2018) defined the stimulation coverage as twice the wormhole radius relative to the length of the perforated interval, which for LEL completions equals the distance between LEL holes.

$${C}_{s} = \frac{2 {r}_{wh}}{Δ {L}_{holes}} \qquad Equation 104$$

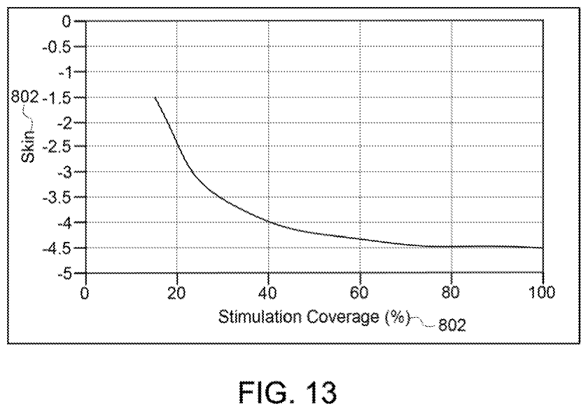

Turing to FIG. 13 which illustrates skin factor as a function of stimulation coverage.

Therefore the skin factor 800 becomes constant when the stimulation coverage 802 reaches 50%.

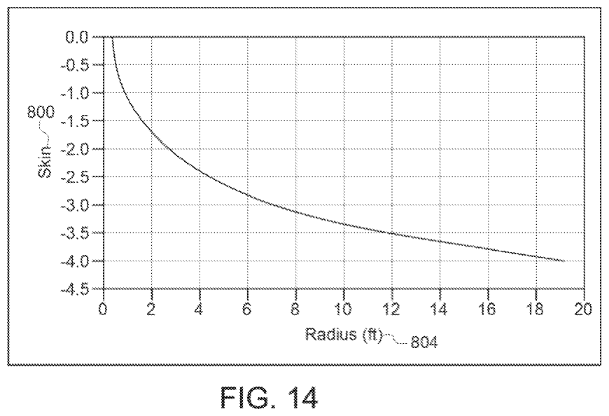

FIG. 14 shows that an effective wormhole radius 804 of 20 ft would result in an equivalent negative skin factor 800 of −4, assuming that all the wormholes generated along the well have the same radius. Combining the two plots shows that the maximum distance between wormholes should not exceed twice the wormhole length. A skin of −3 for the entire well, for instance, means that the holes should be drilled with a maximum distance of 30 ft.

This means that the average distance between LEL holes, defined as the length of the stimulate reservoir section divided by total number of holes, should not exceed twice the expected final wormhole radius. The following check is therefore performed:

$$Δ {L}_{holes} = \frac{{L}_{tot}}{{n}_{holes}} \leq 2 {r}_{wh} \qquad Equation 105$$

If the average hole constraint is not met it becomes necessary to adjust the hole size, block 1034

### Adjust Hole Size 1034:

Based on the evaluation of the above equation, the following possible actions are taken:

If the distance between LEL holes is too small, the LEL hole size can be increased by 1 mm and the entire simulation is then repeated.

If the distance between LEL holes is too large, the LEL hole size can be decreased by 1 mm and the entire simulation is then repeated.

If the average distance between LEL holes is close to or equal to twice the wormhole radius, the algorithm has converged with a final design and proceeds with output of results, block 1036.

### Output Results 1036:

Output results consist of the following items:

Node properties, including position, pressure, rate, friction factor, number of holes per foot, velocity, retention time, stimulation rate, cumulative volume of acid leaving the node through holes.

Segment properties, including segment number, segment interval, number of holes in segment, distance between holes, calculated and design acid coverage, acid coverage ratio, acid stimulation rate, acid velocity at the exit point of the holes, pore volume to breakthrough, final wormhole radius, and final skin factor

Actual versus specified drop in pressure (dp) across last holes

Average overall distance between LEL holes

Total number of LEL holes, total cross-section area of LEL holes, equivalent inner diameter (ID) of total number of LEL holes

Wellhead pressure and bottom-hole pressure during pumping

Wellhead pressure and bottom-hole pressure immediately after shut-in, known as instantaneous shut-in pressure (ISIP)

Acid volume required, total pumping time, assuming pumping occurs at design rate.

Total liner volume, total tubing volume, displacement volume, retention time

A detailed tally list containing the number and size of LEL holes for each joint to be run in hole, as well as the order in which the joints must be run in hole. Furthermore, the total number of joints with a particular number and size of holes is summarised, such as number of joints with 0, 1, 2 or 3 LEL holes of size 3 mm, 4 mm, 5 mm, or 6 mm etc.

Wellhead pressure and bottom-hole pressure during pumping are calculated from the pressure at the first node and then subtracting hydrostatic pressure and adding friction up to the given gauge depth.

Wellhead and bottom-hole instantaneous shut-in pressures ISIP are calculated from the pressure at the first node and then subtracting hydrostatic pressure up to the given gauge depth. The friction is zero because the rate is zero during an ISIP.

### Calculation Procedure:

Input to the numerical design model includes:
Average reservoir pressure
Fracture propagation pressure
Permeability
Porosity
Length of the completed interval
Wellbore radius
Tubing inner diameter (tubing ID), liner inner diameter (liner ID), pipe roughness
Acid properties (type, concentration, density, viscosity)
Number of segments
Acid coverage per segment
Hole size per segment
Discharge Coefficient

Step 1. Estimate the Pump Rate

The software will then estimate the design pump rate based on the standard transient inflow model (not the Darcy model, which is a steady-state assumption) while ensuring that the injection pressure remains below fracturing pressure. Key parameters include the permeability, the length of the completed interval, and the difference between annulus pressure and reservoir pressure. For the calculation, it is assumed that the skin can be reduced to zero. Thus, note that because the stimulation job typically takes less than 24 hours, the injectivity is higher than predicted by the Darcy formulation. The reason is that the boundaries are not yet felt by the pressure pulse emitted during stimulation. So, even though the flow inside the liner is a steady-state formulation, the inflow model used for design of the pump rate is transient.

Step 2. Estimate Wormholing Characteristics

A nodal analysis calculation must be performed to estimate the downhole temperature at the heel of the liner. Based on the choice of acid system, the permeability, and the temperature, the optimum velocity for wormhole propagation is estimated, together with the anticipated pore volume to breakthrough based on published literature data. The Buijse-Glasbergen model is used to characterise the wormholing at different velocities.

Step 3. Estimate Total Number of Holes and the Drop in Pressure (Dp) Across the Last One of the Holes

Based on the optimum velocity and the calculated design pump rate, it is straightforward to calculate the total cross-sectional area of the holes. This cross-sectional area is linearly correlated with the drop in pressure (dP) across the last one of the holes, which is a key design parameter.

Step 4. Estimate Acid Coverage

The stimulation design aims for a negative skin of −3 or better, which requires the holes to be not more than 30-60 ft apart on average. The model by Economides et al. (1994) is used to calculate the acid coverage required to achieve this skin. A higher acid coverage requires more acid and longer pumping time and hence higher cost. This must be weighed against aiming for a more negative skin.

Step 5. Calculate the Optimized Hole Distribution

Provide an initial estimate of the number of holes per segment and let the software find the solution which honours the acid coverage per segment and the drop in pressure (dp) across the last one of the holes. The initial estimate can be found from the relationship between interstitial velocity, pump rate, and total cross-sectional hole area for a particular discharge coefficient and liner configuration.

### EXAMPLE

To illustrate the design concept in more detail, an example is shown below. The well in question will have an approximate reservoir length of some 7000 ft. Since a stand (3 drill pipe lengths) is approximately 91 ft, the well is numerically split into 8 segments, each with a length of 910 ft, corresponding to 10 stands.

The initial design coverage is set to 1 bbl/ft. The transient inflow equation predicts that the maximum rate without fracturing the formation is 20 bpm, assuming that the skin is zero. As the stimulation progresses, the rate can be increased further. The resulting pumping time will be 6 hours, which leads to a slight adjustment of the design rate, but not much.

Although the reservoir temperature is 250 F or more, nodal analysis based on the design rate of 20 bpm predicts a BHT of 140 F at the first hole. This temperature is used for estimating the position of the optimum velocity for wormhole propagation based on a measured curve and the Buijse-Glasbergen model.

The final skin is initially assumed to be −3, which yields a maximum distance between adjacent holes of 30 ft. This corresponds to a drop in pressure (dp) across the last one of the holes of about 30 psia, which is then used as input for the design model.

The discharge coefficient is assumed to be 0.70, which is mid-way between the theoretical minimum of 0.56 and a high value of 0.85-0.90. Post-job analysis will help identify the drop in pressure (dp) across the holes and hence the actual discharge coefficient.

A first estimate of the hole size distribution makes use of a linear relationship between hole cross-section area and drop in pressure (dp) across the last one of the holes. Based on this initial input, the actual optimum hole size distribution is calculated using the numerical algorithm outlined. In the inner loop, the flow equations are solved. In the outer loop, the number of holes is adjusted to match the drop in pressure (dp) across the last one of the holes as well as the acid coverage for each segment.

The results from the calculations are show in the four plots above. The distance between adjacent holes is in the range 20-35 ft, which yields optimum stimulation coverage (wormholes cover the entire well length). The distance is not uniform because the hole size is chosen to be constant at 4 mm to avoid complicating the pilot design.

Based on the wormhole growth model of PVbt versus interstitial rate, the minimum PVbt to be inserted into the skin model by Economides and based on the specified acid coverage of 1.0 bbl/ft. This yields a skin factor of −2.5, which is considered close enough to the initial estimate of −3. If a skin of −3 is desired, we would need to increase the acid coverage, recalculate the pumping time, recalculate the flow rate, redesign the hole sizes and then check the resulting skin.

While the embodiment of the invention has been described above and discussed in detail, the invention is not deemed to be restricted to this particular embodiment. A person skilled in the art will appreciate that a number of variations may be made to the described embodiment or features thereof, without departing from the scope of the present invention.

In particular, the invention is not deemed to be limited to use in LEL-liners, as has been described. Other systems involving material flow through conduits and/or material formations may benefit from the implementation of the current invention, and embodiment, as described above.

### REFERENCES

1. Al-Ghamdi, A. H., Mahmoud, M. A., Wang, G., Hill, A. D., Nasr-El-Din, H. A. (2014). Acid Diversion by Use of Viscoelastic Surfactants: The Effects of Flow Rate and Initial Permeability Contrast. SPE-142564-PA, SPE J. (December 2014), 1203-1216.
2. Bernadiner, M. G., Thompson, K. E., Fogler, H. S. (1992). Effect of Foams used during Carbonate Acidizing. SPE Prod. Eng. (November 1992), 350-356.
3. Buijse, M. and Glasbergen, G. (2005). A Semi-empirical Model to Calculate Wormhole Growth in Carbonate Acidizing. SPE-96892-MS, presented at the SPE Annual Technical Conference and Exhibition, Dallas, Tex., U.S.A, 9-12 Oct. 2005.
4. Crump, J. B. and Conway, M. W. (1988). Effects of Perforation-Entry Friction of Bottom-hole Treating Analysis. SPE 15474, JPT (August 1988), 1041-1048.
5. Dong, K., Jin, X., Zhu, D., Hill, A. D. (2014). The Effect of Core Dimensions on the Optimum Acid Flux in Carbonate Acidizing. SPE-168146-MS, presented at the International Conference and Exhibition on Formation Damage Control, Lafayette, La., USA, 26-28 Feb. 2014.
6. Dong, K., Jin, X., Zhu, D., Hill, A. D. (2016). Theoretical and Experimental Study on Optimal Injection Rates in Carbonate Acidizing. SPE-178961-MS, presented at the International Conference and Exhibition on Formation Damage Control, Lafayette, La., USA, 24-26 Feb. 2016.
7. Dubetz, D., Cheng, H., Zhu, D., Hill, A. D. (2016). Characterization of Rock Pore-Size Distribution and Its Effects on Wormhole Propagation. SPE-181725-MS, presented at the SPE Annual Technical Conference and Exhibition, Dubai, UAE, 26-28 Sep. 2016.
8. Economides, M. J., Hill, A. D., Ehlig-Economides, C. A. (1994). Petroleum Production Systems, Prentice-Hall, New York, N.Y.
9. El-Rabba, A. M., Shah, S. N., Lord, D. L. (1997). New Perforation Pressure-Loss Correlations for Limited-Entry Fracturing Treatments. SPE-54533-PA, SPE Prod. & Facilities 14(1).
10. Etten, J., Zhu, D., Hill, A. D. (2015). The Combined Effect of Permeability and Pore Structure on Carbonate Matrix Acidizing. SPE-174314-MS, presented at EUROPEC 2015, Madrid, Spain, 1-4 Jun. 2015.
11. Fernandes, P. D., da Silva, M. G. F., Bedrikovetsky, P. (2006). A New IOR Technology to Homogenize Horizontal Well Injectivity/Productivity Profile. SPE-99343-MS, presented at the SPE/DOE Symposium on Improved Oil Recovery, Tulsa, Okla., USA, 22-26 Apr. 2006.
12. Fredd, C. N., Fogler, H. S. (1996). Alternative Stimulation Fluids and Their Impact on Carbonate Acidizing. SPE-31074-PA, SPE J. (March 1998), 34-41.
13. Fredd, C. N., Tjia, R., Fogler, H. S. (1997). The Existence of an Optimum Damkohler Number for Matrix Stimulation of Carbonate Formations. SPE-38167-MS, presented at the SPE European Formation Damage Conference, The Hague, The Netherlands, 2-3 Jun. 1997.
14. Fredd, C. N., Fogler, H. S. (1997). Chelating Agents as Effective Matrix Stimulation Fluids for Carbonate Formations. SPE-37212-MS, SPE-38167-MS, presented at the SPE International Symposium on Oilfield Chemistry, Houston, Tex., USA, 18-21 Feb. 1997.
15. Fredd, C. N., Fogler, H. S. (1999). Optimum Conditions for Wormhole Formation in Carbonate Porous Media: Influence of Transport and Reaction. SPE-56995-PA, SPE J. 4(3), 196-205.
16. Furui, K., Zhu, D., Hill, A. D. (2005). A Comprehensive Skin Factor Model of Horizontal Well Completion Performance. SPE-84401-PA, SPE Production & Facilities (August 2005), 207-220.
17. Furui, K., Zhu, D., Hill, A. D. (2008). A New Skin Factor Model for Perforated Horizontal Wells. SPE-77363-PA, SPE Drilling & Completion (September 2008), 205-215
18. Furui, K., Burton, R. C., Burkhead, D. W., Abdelmalek, N. A., Hill, A. D., Zhu, D. and Nozaki, M. (2010). A Comprehensive Model of High-Rate Matrix-Acid Stimulation for Long Horizontal Wells in Carbonate Reservoirs: Part I—Scaling Up Core-Level Acid Wormholing to Field Treatments. SPE-134265-PA, presented at presented at the SPE Annual Technical Conference and Exhibition, Florence, Italy, 19-22 Sep. 2010.
19. Furui, K., Burton, R. C., Burkhead, D. W., Abdelmalek, N. A., Hill, A. D., Zhu, D. and Nozaki, M. (2010). A Comprehensive Model of High-Rate Matrix-Acid Stimulation for Long Horizontal Wells in Carbonate Reservoirs: Part II—Wellbore/Reservoir Coupled Flow Modeling and Field Application. SPE-155497-PA, presented at the SPE Annual Technical Conference and Exhibition, Florence, Italy, 19-22 Sep. 2010.
20. Gdanski, R. D., Norman, L. R. (1986). Using the Hollow-Core Test to Determine Acid Reaction Rates. SPE-12151-PA, SPE Prod. Eng. (March 1986), 111-117.
21. Gdanski, R., van Domelen, M. S. (1999). Slaying the Myth of Infinite Reactivity of Carbonates. SPE-50730-MS, presented at the International Symposium on Oilfield Chemistry, Houston, Tex., 16-19 Feb. 1999.
22. Gdanski, R. (1999). A Fundamentally New Model of Acid Wormholing in Carbonates. SPE-54719-MS, presented at the European Formation Damage Conference, The Hague, The Netherlands, 31 May-1 Jun. 1999
23. Hansen, J. H. (2001). A method of stimulating a well. EP1184537B1, filed 31 Aug. 2001.
24. Hansen, J. H. and Nederveen, N. (2002). Controlled Acid Jet (CAJ) Technique for Effective Single Operation Stimulation of 14,000+ft Long Reservoir Sections. SPE-78318-MS, presented at the SPE 13th European Petroleum Conference, Aberdeen, Scotland, U.K., 29-31 Oct. 2002.
25. Hansen, J. H., Mogensen, K. (2012). Flow Simulation in a Well or Pipe. U.S. Pat. No. 8,321,190B2, PCT filed 24 May 2006.
26. Hashim, A. M., Stemberger, D. J., Mulrooney, M. (2013). Novel Technology for Downhole Reality Check and Realization—A Case Study of Real-Time Monitoring of High-Rate Matrix Acid Stimulation Treatments in a Tight Chalk Reservoir using Distributed Temperature Sensing. SPE-167420-MS, presented at the SPE Middle East Intelligent Energy Conference and Exhibition, Dubai, UAE, 28-30 Oct. 2013.
27. Hoefner, M. L., Fogler, H. S., Stenius, P., Sjoblom, J. (1987). Role of Acid Diffusion in Matrix Acidizing of Carbonates. SPE-13564-PA, JPT (February 1987), 203-208.
28. Hoefner, M. L., Fogler, H. S. (1989). Fluid Velocity and Reaction Rate Effects during Carbonate Acidizing: Application of Network Model. SPE Prod. Eng. (February 1989), 56-62.
29. Issa, F., Abbott, J., Akbari, A. (2014). Production Optimization of Maximum Reservoir Contact Well by Utilizing Acid Stimulation with Limited Entry Technique. SPE-171779-MS, presented at the Abu Dhabi International Exhibition and Conference, Abu Dhabi, UAE, 10-13 Nov. 2014.
30. Izgec, O., Keys, R., Zhu, D., Hill, A. D. (2008). An Integrated Theoretical and Experimental Study on the Effects of Multiscale Heterogeneities in Matrix Acidizing of Carbonates. SPE-115143-MS, presented at the SPE Annual Technical Conference and Exhibition, Denver, Colo., 21-24 Sep. 2008.
31. Lagrone, K. W. and Rasmussen, J. W. (1963). A New Development in Completion Methods—The Limited Entry Technique. SPE-530, presented at the SPE Rocky Mountains Regional Meeting, Denver, Colo., U.S.A., 27-28 May 1963.
32. McDuff, D. R., Shuhart, C. E., Jackson, S. K., Postl, D., Brown, J. S. (2010). Understanding Wormholes in Carbonates: Unprecedented Experimental Scale and 3-D Visualization. SPE-134379-MS, presented at the SPE Annual Technical Conference and Exhibition, Florence, Italy, 19-22 Sep. 2010.
33. McLemore, A. J., Tyner, J. S., Yoder, D. C., Buchanan, J. R. (2013). Discharge Coefficients for Orifices Cut into Round Pipes. J. Irrig. Drain Eng. 139, 947-954.
34. Mitchell, D., Davis, J., Appleton, J., Watson, M. (2014). First Successful Application of Horizontal Open Hole Multistage Completion Systems in Turkey's Selmo Field. SPE-170777-MS, presented at the SPE Annual Technical Conference and Exhibition, Amsterdam, The Netherlands, 27-29 Oct. 2014.
35. Mogensen, K., Hansen, J. H. (2007). A Dynamic Model for High-Rate Acid Stimulation of Very Long Horizontal Wells. SPE-110135-MS, presented at the SPE Annual Technical Conference and Exhibition, Anaheim, Calif., USA, 11-14 Nov. 2007.
36. Ndonhong, V., Belostrino, E., Zhu, D., Hill, A. D., Beckham, R. E., Shuchart, C. E. (2016). The Impact of Rock Properties on Acid Jetting in Carbonate Rocks: An Experimental Study. SPE-180113, presented at 78th EAGE Conference and Exhibition, Vienna, Austria, 30 May-2 Jun. 2016.
37. Ndonhong, V., Zhu, D., Hill, A. D. (2018). Acid Jetting on Carbonate Rocks: A Computational Fluid Dynamics Study at Laboratory Scale. SPE-190849-MS, presented at 80th EAGE Conference and Exhibition, Copenhagen, Denmark, 11-14 Jun. 2018.
38. Punnapala, S., Rahman, M. A., Misra, S. (2014). Challenge of Acidizing Horizontal Wells in Tight Carbonate Reservoirs—Weak Acid and Non-Acid Alternates. SPE-171766-MS, presented at the Abu Dhabi International Exhibition and Conference, Abu Dhabi, UAE, 10-13 Nov. 2014.
39. Rodrigues, V. D. Neumann, L. F., Torres, D., Guimarães, C., Tones, R. S. (2007). Horizontal Well Completion and Stimulation Techniques—A review with Emphasis on Low-Permeability Carbonates. SPE-108075-MS, presented at the SPE Latin American and Caribbean Petroleum Engineering Conference, Buenos Aires, Argentina, 15-18 Apr. 2007.
40. Sasongko, H., Zhu, S., Hill, A. D. (2011). Acid Placement in Acid Jetting Treatments in Long Horizontal Wells. SPE-144200, presented at the SPE European Formation Damage Conference, Noordwijk, The Netherlands, 7-10 Jun. 2011.
41. Sau, R., Grubert, M. (2014). Advanced Completion and Stimulation Design Model for Maximum Reservoir Contact Wells. SPE-171800-MS, presented at the Abu Dhabi International Exhibition and Conference, Abu Dhabi, UAE, 10-13 Nov. 2014.
42. Schwalbert, M. P., Zhu, D., Hill, A. D. (2018). Skin Factor Equations for Anisotropic Wormhole Networks and Limited Entry Completions. SPE-189486-MS, presented at the International Conference and Exhibition on Formation Damage Control, Lafayette, La., USA, 7-9 Feb. 2018.
43. Shirley, R. M., Zhu, D., Hill, A. D., Da Motta, E. P. (2017). Maximizing the Value of Matrix Acidizing Treatments in Carbonate Reservoirs. SPE-185812-MS, presented at the 79th EAGE Conference and Exhibition, Paris, France, 12-15 Jun. 2017.
44. Shokry, A. F. (2010). Acid Stimulation Results of Arab Carbonate Reservoirs in Offshore Field, UAE: 10 Years of Review, How to Prepare the Future Challenges Linked to Stimulation. SPE-138357-MS, presented at the Abu Dhabi International Exhibition and Conference, Abu Dhabi, UAE, 1-4 Nov. 2010.
45. Shukla, S., Zhu, D., Hill, A. D. (2006). The Effect of Phase Saturation Conditions on Wormhole Propagation in Carbonate Acidizing. SPE-82273-PA, SPE J. (September 2006), 273-281.
46. Troshko, A. A., Brown III, J. S., Shuchart, C. E. (2015). Fluid Stimulation of Long Well Intervals. US2015/0041123A1, filed 4 Oct. 2012.
47. Van Domelen, M., Talib, N., Glasbergen, G. (2011). Return to Basics and Proper Planning Opens the Possibility to Acid Stimulate a Difficult Chalk Formation. SPE-144159-MS, presented at the SPE European Formation Damage Conference, Noordwijk, The Netherlands, 7-10 Jun. 2011.
48. Van Domelen, M., Abd Hammoud, M., Glasbergen, G., Talib, N. (2012). Optimization of Limited Entry Matrix Acid Stimulations with Laboratory Testing and Treatment Pressure Matching. SPE-157429-MS, presented at the SPE International Production and Operations Conference and Exhibition, Doha, Qatar, 14-16 May 2012.
49. Virk, P. S. (1971). Drag Reduction in Rough Pipes. J. Fluid Mech. 45, 225-246.
50. Virk, P. S. (1975). Drag Reduction Fundamentals. AIChE J. 21, 625-656

1. A method of simulating fluid transport of an acid in a system for stimulating an oil or gas well in a material formation, which system comprises a limited entry liner, wherein the limited entry liner is divided into a plurality of segments, the plurality of segments having a length less than that of a total length of the limited entry liner, and including one or more holes along a wall of the limited entry liner for discharging a fluid into the material formation, wherein the method comprises
calculating an initial estimate of the number of holes along the wall of the limited entry liner and an estimated cross-sectional area of the holes, wherein the estimated cross-sectional area is based on a velocity for providing the amount of the acid needed to generate dissolution patterns and a pump rate for keeping an injection pressure below a fracturing pressure of the material formation of the oil or gas well, wherein the initial estimate of the number of holes along the wall of the limited entry liner is calculated to enable a sufficient acid coverage of the acid per segment and a sufficient pressure across a last one of the holes, wherein a drop in pressure (dp) across the last one of the holes is linearly correlated with the estimated cross-sectional area, and
adjusting the initial estimate of the number of holes along the wall of the limited entry liner if a measured acid coverage per segment and the drop in pressure across the last hole is not honoured.

2. The method according to claim 1, wherein the calculating step includes the steps of performing a series of algebraic equations for an initial hole-size distribution guess; calculating the acid coverage and the drop in pressure (dp) across the last hole; comparing the acid coverage and the drop in pressure (dp) across the last one of the holes against a design variable in a first iteration; evenly decreasing the number of the holes across one or more of the segments for the next iteration until the drop in pressure (dp) across the last hole is honoured; or evenly increasing the number of the holes across the one or more of the segments for the next iteration until the drop in pressure (dp) across the last hole is honoured, as a first step; and performing a second step which includes; redistributing an existing number of the holes between various ones of the one or more segments as a first iteration; exchanging one hole for the segments, where the calculated acid coverage is the furthest away from design values; performing the next iteration until the acid coverage is honoured; and performing the first step and the second step until the drop in pressure (dp) across the last hole and the acid coverage is honoured.

3. The method according to claim 1, wherein the method includes the steps of running a simulation once the drop in pressure (dp) across the last one of the holes and the acid coverage is honoured to determine a wellhead pressure; adjusting a friction reducer and re-running the simulation if the wellhead pressure exceeds a maximum wellhead pressure rating; and/or increasing a tubing inner diameter (tubing ID) in presence of an existing friction reducer; and/or reducing a pump rate, such that the maximum wellhead pressure rating is maintained below the maximum wellhead pressure rating.

4. The method according to claim 1, wherein the method includes the steps of running a simulation to determine whether a distance between neighbouring ones of the holes along the wall of the limited entry liner does not exceed twice the expected final radius of a wormhole formed along the limited entry liner; increasing the size of the holes along the wall of the limited entry liner by an amount if the distance between the neighbouring ones of the holes along the wall of the limited entry liner is too small, and repeating the simulation; or decreasing the size of the holes along the wall of the limited entry liner by an amount if the distance between the neighbouring ones of the holes along the wall of the limited entry liner is too large, and repeating the simulation; or proceeding with an output of results if the distance between the neighbouring ones of the holes along the wall of the limited entry liner holes is close or equal to twice the wormhole radius.

5. The method according to claim 1, wherein the calculating step includes honoring the constraints of; an annulus pressure, an exceeding minimum reservoir pressure to avoid cross-flow inside a wellbore; the annulus pressure does not exceed a fracturing pressure to avoid fracturing; the wellhead pressure does not exceed a maximum design pressure rating; the cross-sectional area of all of the holes along the wall of the limited entry liner combined may be equal to or exceed a minimum cross-sectional area to avoid creating an additional drop in pressure (dp) during normal production or injection of the acid into the well after stimulation; an average distance between two neighbouring holes along the wall of the limited entry liner may be equal to twice the wormhole radius; and a liner inner diameter (liner ID) not exceeding the wellbore size.

6. The method according to claim 1, wherein the method includes providing an initial estimate of the number of the holes along the wall of the limited entry liner across the segment of the limited entry liner which honors the acid coverage per that segment and the drop in pressure (dp) across the last one of the holes for that segment, for an hole-size distribution in construction and operation of the system, and adjusting the initial estimate of the number of the holes along the wall of the limited entry liner across the segment if the acid coverage per segment and the drop in pressure (dp) across the last one of the holes for the segment is not honoured.

7. The method according to claim 1, wherein simulating the fluid transport comprises simulating the fluid transport in a limited entry liner.

8. The method according to claim 3, wherein the simulation is performed in discrete steps and each step required to be completed before the following step may take place.

9. The method according to claim 1 comprising using a data processing system configured to perform the calculating and adjusting steps.

10. A data processing system configured to perform the steps of the method as described in claim 1 for stimulating a well.

11. The data processing system as claimed in claim 10 which includes any electronic system or device having a processor configured to perform the steps of the method, and to communicate the outcome of those steps to a user of the system or device, which system or device includes, but is not limited to, a computer, a laptop, a handheld electronic device, or electronic workstation.
